(19) United States
(12) Patent Application Publication
(10) Pub. No.: US 2015/0161906 A1
(43) Pub. Date: Jun. 11, 2015

(54) POSITIVE REINFORCEMENT TRAINING DEVICE

(71) Applicant: Christopher Scott Lorkowski, Apex, NC (US)

(72) Inventor: Christopher Scott Lorkowski, Apex, NC (US)

(21) Appl. No.: 14/563,254

(22) Filed: Dec. 8, 2014

Related U.S. Application Data
(60) Provisional application No. 61/913,526, filed on Dec. 9, 2013.

(51) Int. Cl. G09B 19/00; A01K 5/02; A01K 29/00; G09B 5/00; A01K 15/02

(52) U.S. Cl. CPC G09B 19/00; G09B 5/00; A01K 15/021; A01K 29/00; A01K 5/02

(57) ABSTRACT

A system and method for positive reinforcement training is disclosed. In one embodiment, a user is rewarded for depositing and/or removing items into a receptacle. In one embodiment, a positive reinforcement training device is provided, the device comprising: a receptacle with an inner volume; a power supply; a sensor operatively connected to the power supply and operatively arranged to sense at least one of an addition and a removal of one or more items to the inner volume; a reward dispensing system operatively connected to the power supply and the sensor, such that the sensor sensing the addition of items to the inner volume selectively triggers the reward dispensing system to selectively dispense a reward.

### CROSS-REFERENCE TO RELATED APPLICATIONS

This application claims priority from U.S. Provisional Patent Application No. 61/913,526, filed on Dec. 9, 2013, which is incorporated by reference herein in its entirety.

### BACKGROUND

Training is the process of modifying the behavior of a cognitive organism to: have the cognitive organism assist in particular activities; have the cognitive organism undertake particular tasks; and have the cognitive organism participate effectively in everyday life. Often, training is used in the context of pets and children.

Operant conditioning is a common learning and training technique in which a cognitive organism's behavior is modified by the behavior's consequences. These consequences include both reinforcement and punishment. One such consequence is positive reinforcement in which a cognitive organism's behavior is rewarded to encourage a greater frequency of the particular behavior.

Toys are common items used for play by both children and pets. Toys are an enjoyable means to discover identity, grow strong, learn cause and effect, explore relationships, and practice skills needed later in life. While play time may be a fun activity, one common problem with toys is that they are often left strewn about by children and pets after play time is over instead of returned to an original place of storage. Scattered toys may be an eyesore and in some instances may cause injury from slippage or coming into contact with one's foot. Accordingly, what is needed is a positive reinforcement training device used to encourage pets and children to put away their toys.

### SUMMARY

In one embodiment, a positive reinforcement training device is provided, the positive reinforcement training device comprising: a receptacle with an inner volume; a power supply; a sensor; and a reward dispensing system operatively connected to the power supply and the sensor, such that the sensor sensing the addition of items to the inner volume selectively triggers the reward dispensing system to selectively dispense a reward.

In another embodiment, a positive reinforcement training device is provided, the positive reinforcement device comprising: a receptacle comprising a base surface and one or more side surfaces, the one or more side surfaces connected substantially perpendicular to the base surface, wherein a volume enclosed by the one or more side surfaces and the base surface defines an inner volume; a power supply; a sensor operatively connected to the power supply and operatively arranged to sense at least one of an addition and a removal of the one or more items to be stored in the inner volume; a reward dispensing system operatively connected to the power supply and the sensor, such that the sensor sensing the addition of items to the inner volume selectively triggers the reward dispensing system to selectively dispense a reward, the reward dispensing system further comprising at least one of: a reward storage area, the reward storage area operable to hold, store, prevent access to the reward until a reward triggering event, a reward feeder mechanism, the reward feeder mechanism operable to selectively convey one or more rewards from the reward storage area to an award dispensing aperture, the reward feeder mechanism operatively connected to the reward storage area, and a reward dispensing aperture, the reward dispensing aperture operable to dispense one or more rewards from the reward feeder mechanism after the reward triggering event.

In one embodiment, a method for positive reinforcement training using a positive reinforcement training device is provided, the method comprising: adding one or more removable items to be stored in a receptacle; sensing the addition of the one or more removable items to be stored in the receptacle and triggering a reward event; communicating the triggering of the reward event to a reward dispensing mechanism; selecting one or more rewards to be dispensed by the reward dispensing system; and dispensing the one or more rewards to reward a user for adding the one or more items to be stored in a receptacle.

### BRIEF DESCRIPTION OF THE DRAWINGS

The accompanying figures, which are incorporated in and constitute a part of the specification, illustrate various example systems and method and used merely to illustrate various example embodiments.

FIG. 1 illustrates a top elevational view of one embodiment of a positive reinforcement training device.

FIG. 2 illustrates a front elevational view of one embodiment of a positive reinforcement training device.

FIG. 3 illustrates a perspective view of one embodiment of a positive reinforcement training device.

FIG. 4 illustrates a side sectional view of one embodiment of a reward dispensing system of a positive reinforcement training device.

FIG. 5 illustrates a perspective view of one embodiment of a reward dispensing system of a positive reinforcement training device.

FIG. 6 illustrates a flowchart depicting one embodiment of a method of using a positive reinforcement training device.

### DETAILED DESCRIPTION

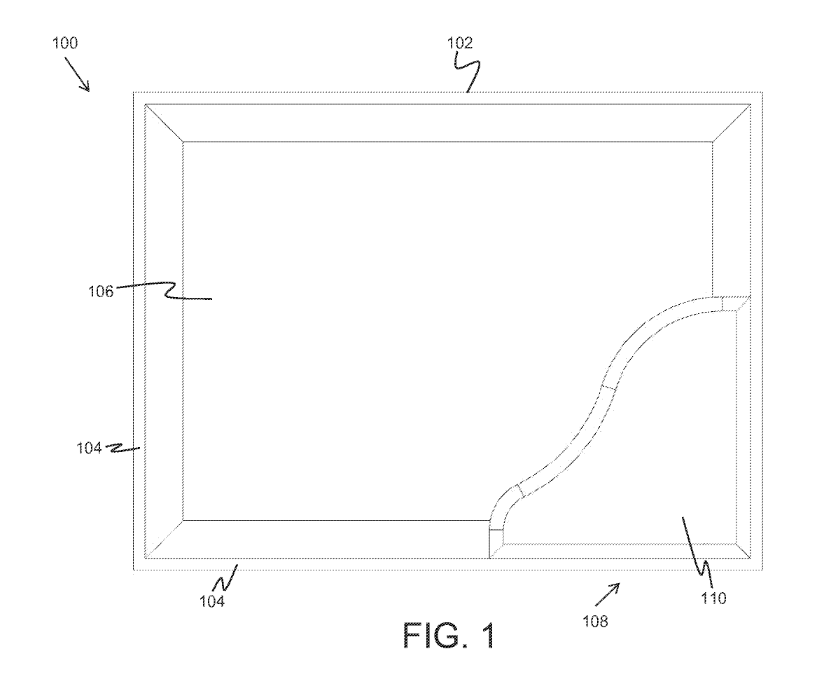

FIGS. 1, 2, and 3 illustrate different views of a positive reinforcement training device 100. Positive reinforcement training device 100 may be used to train any cognitive organism, such as humans and animals. Positive reinforcement training device 100 may reward a cognitive organism for completing a task. Positive reinforcement training device 100 may be used to train a pet such as a dog or cat. Positive reinforcement training device 100 may be used to train and reward a dog or cat with a reward such as a treat or other food item dispensed from reward dispensing system 108 for placing any item, such as toys, laundry, sticks from nature, trash, evidence, contraband, or the like, in a bin or receptacle 102. Positive reinforcement training device 100 may be used to train a cognitive organism such as a pet or child to place items in receptacle 102. Positive reinforcement training device 100 may be used to crate train an animal. Positive reinforcement training device 100 may be used to toilet train/litter train/house train a cognitive organism.

Receptacle 102 may comprise a base 106 and one or more sides 104 which connect to base 106. Sides 104 may connect to base 106 in a substantially perpendicular arrangement. Base 106 and sides 104 may be quadrilateral such that receptacle 102 has four sides. Base 106 may be circular with side 104 being cylindrical in shape. Base 106 may be any of a variety of shapes, and sides 104 may be configured to substantially match the shape or orientation of base 106. Sides 104 may connect to base 106 completely perpendicularly. Sides 104 may connect to base 106 at slightly acute or slightly obtuse angles such that sides 104 are flared relative to base 106 to vary the volume of receptacle 102. Sides 104 may connect to base 106 at slightly obtuse angles flaring sides 104 outward from base 106 such that the volume of receptacle 102 is increased.

Receptacle 102 may be sized appropriately to assist a cognitive organism in training Receptacle 102 may be sized such that a variety of dog breeds may take toys from, and deposit toys to, receptacle 102. Receptacle 102 may be sized to accommodate a specific size of pet, including for example, a cat, a small dog, a medium size dog, a large dog, a horse, and the like. Receptacle 102 may be sized to accommodate a specific size of human, including for example, an infant, a toddler, a preschooler, a school age child, a preteen, a teen, an adult, and the like. Receptacle 102 may used for crate training and receptacle 102 may vary in size to accommodate a size of dog breed, wherein the dog or other pet actually proceeds to enter receptacle 102. Receptacle 102 may be used to toilet train/litter train/house train a cognitive organism and receptacle 102 may be sized to allow a particular cognitive organism (e.g. human, cat, dog) to interact with receptacle 102, and receptacle 102 may be shaped to contain a waste product from a cognitive organism.

Receptacle 102 may be made of a substantially rigid and durable material such as a metal, a polymeric material or plastic, a wood, and the like. Receptacle 102 may be a polymeric material easily manufactured by a process such as injection molding or blow molding.

Positive reinforcement training device 100 may include reward dispensing system 108 within an inner volume of receptacle 102. Alternatively, reward dispensing system 108 may be external to receptacle 102. Reward dispensing system 108 may be attached to receptacle 102, or reward dispensing system 108 may be completely remote from receptacle 102. Reward dispensing system 108 may be close to receptacle 102 such that cognitive organisms associate placing items in receptacle 102 with receiving a reward from reward dispensing system 108.

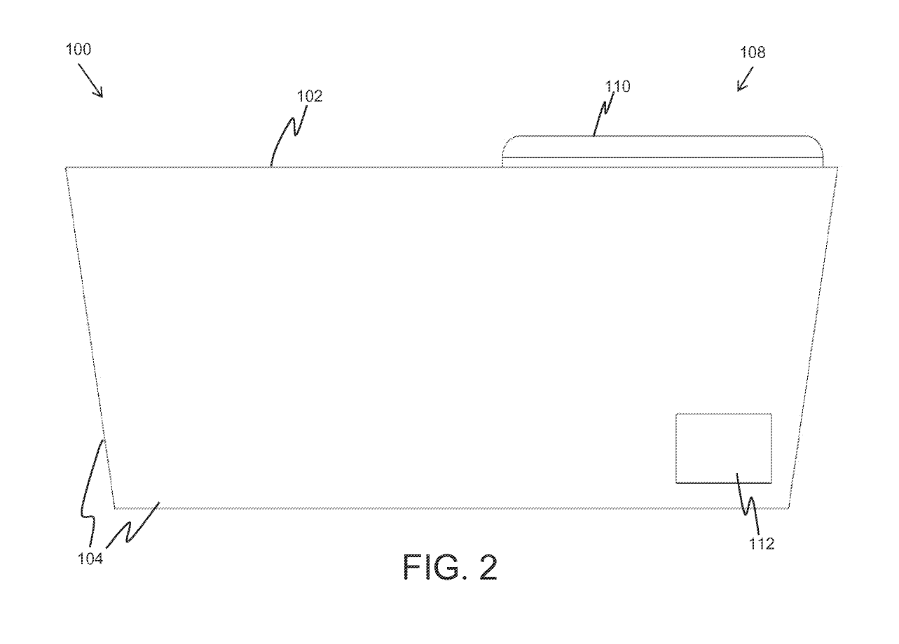

With reference to FIGS. 1 and 2, reward dispensing system 108 may be mounted within the inner volume and contained in an upper corner attached to at least one of sides 104 of receptacle 102. Reward dispensing system 108 may comprise a reward dispensing system cover 110. Reward dispensing system cover 110 may be used to prevent unauthorized access (e.g., bypassing reward triggering event) to rewards contained within reward dispensing system 108. Reward dispensing cover 110 may be secured to reward dispensing system 108 by at least one of: a press fit attachment, a threaded attachment, a hook and loop fastener, a magnet, a hinge, a latch, a hasp, gravity, and other like mechanical fasteners. Reward dispensing cover may comprise a lock or like mechanical device to prevent unauthorized access into reward dispensing system 108.

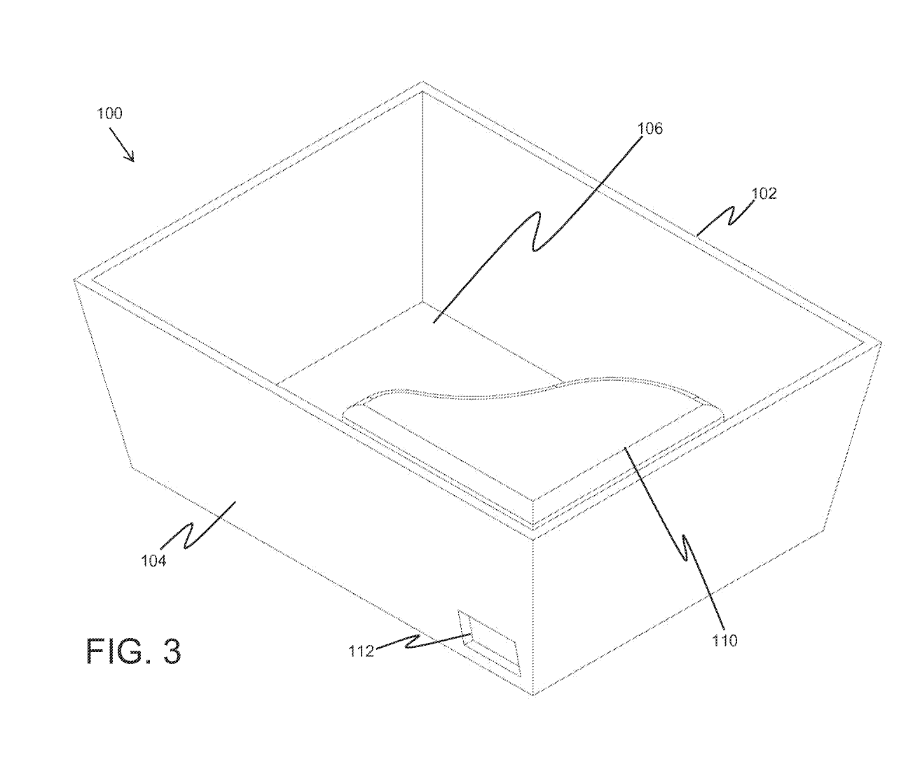

Referring to FIGS. 2 and 3, reward dispensing system 108 may be contained within the inner volume of receptacle 102, and rewards may be dispensed through a reward dispensing aperture 112 on side 104 of receptacle 102. Reward dispensing system 108 may be contained outside the inner volume of receptacle 102, and rewards may be dispensed through reward dispensing aperture 112. Reward dispensing system 108 may be contained outside the inner volume of receptacle 102, and rewards may be dispensed from an apparatus apart from receptacle 102. Reward dispensing aperture 112 may contain a door, a one-way door, a gate, or other device (not shown) to prevent access to reward dispensing system 108 via reward dispensing aperture 112.

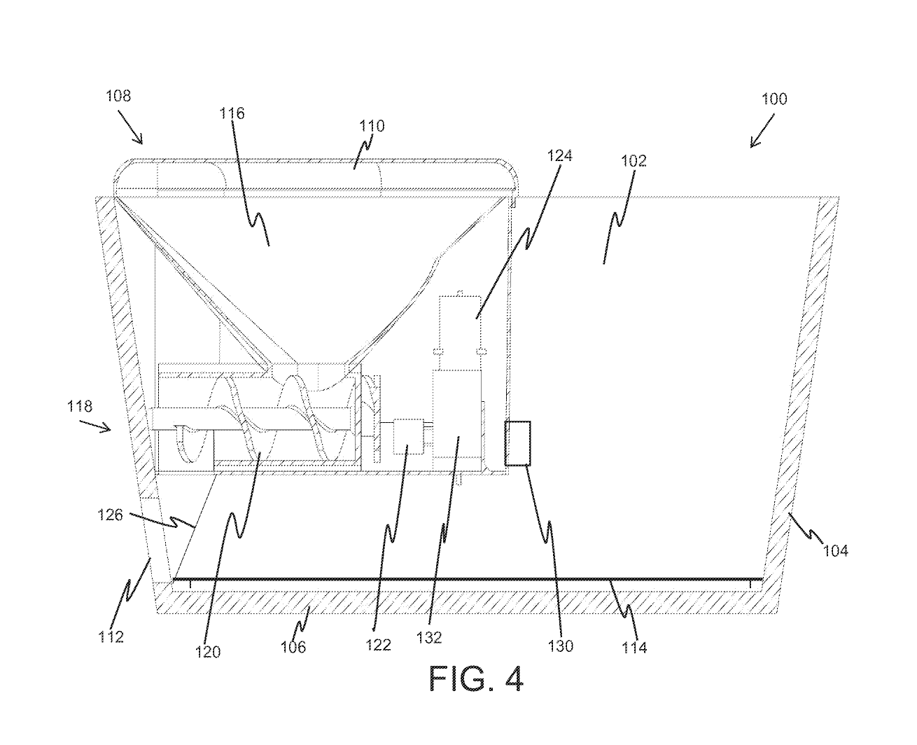

With reference to FIG. 4, positive reinforcement training device 100 may include a reward dispensing system 108 within receptacle 102 as shown. Reward dispensing system 108 may contain reward storage area 116. Reward dispensing system 108 may include a reward feeder mechanism 118. The rewards may be any of a variety of rewards, including for example, foods, snacks, treats, money, trinkets, toys, tokens, or any other items that might be desirable to a human or animal. Reward storage area 116 may be sized and shaped to appropriately contain rewards. In one embodiment, a reward is a pet treat, pet kibble, loose candy, and the like, and reward storage area 116 may be a funnel-shaped hopper configured to hold a large volume of rewards and funnel rewards to reward feeder mechanism 118. A reward may be a dog treat or wrapped candy bar and reward storage area may be rectangular in shape to accommodate stacked dog treats or wrapped candy bars and convey dog treats (including for example, bone-shaped treats) or wrapped candy bars to reward feeder mechanism 118. A reward may be a tennis ball and reward storage area 116 may be cylindrical in shape to accommodate one or more tennis balls and convey tennis balls to reward feeder mechanism 118. A reward may be a sticker and reward storage area 116 may be either flat in shape to accommodate a stack of stickers and convey stickers to reward feeder mechanism 118 or reward storage area may be cylindrical in shape to hold a roll of stickers and convey stickers to reward feeder mechanism 118. A reward may be, or may include, a light, sound, or other positive reward, and reward feeder mechanism 118 may comprise at least one light, speaker, bell, buzzer, or the like.

Reward feeder mechanism 118 may be varied depending on rewards dispensed from reward dispensing system 108. Reward feeder mechanism 118 may use an auger 120 to convey small rewards, such as kibble or loose candy, from reward storage area 116 through reward dispensing aperture 112. Auger 120 may be fine-tuned mechanically, electro-mechanically, or electrically to control a reward amount. For example, different sized augers 120 may dispense different portions of rewards. The size of auger 120 may be varied depending on dog breed. Additionally, augers having different speeds may dispense rewards at different rates. Augers running for different amounts of time may dispense more or less rewards. Auger 120 may be substituted for any feeder device, including for example a conveyer, an air blower, a gravity feeder, a piston, and the like.

Likewise, an electrical control 132 may interface with and be in electrical connection with both motor 122 and power supply 124 to vary power to motor 122, such that the longer power is supplied to motor 122, the longer auger 120 may be rotated producing more reward. Auger 120 may be rubberized to prevent rewards from jamming auger 120. Reward feeder mechanism 118 may be equipped with a sensor (not shown) to reverse rotation of auger 120 when a jam is sensed to prevent damage to motor 122.

Motor 122 may be any motor common in the art of dispensing and automation including: a gear motor, a stepper motor, and the like.

Motor 122, reward feeder mechanism 118, sensors 114 and 130, and electrical control 132 may be powered by power supply 124. Power supply 124 may be one or more batteries. Power supply 124 may be an external power source such as an electrical outlet. Positive reinforcement device 100 may be hardwired to interface with an electrical outlet. Positive reinforcement device 100 may use a power jack (not shown) to interface with a transformer plugged into an electrical outlet, such that positive reinforcement device 100 may be used with batteries or with electricity supplied by an electrical outlet.

Electrical control 132 may be any type of electrical control known in the art, such as: integrated circuit (IC), programmable memory (RAM, ROM, EEPROM), microcontroller, and the like.

Reward feeder mechanism 118 may comprise another mechanical or electro-mechanical device different from auger 120. Reward feeder mechanism 118 may be an electro-mechanical actuator that pushes reward from reward dispensing system 108 through reward dispensing aperture 112. Reward feeder mechanism 118 may be an electro-mechanical trapdoor that releases reward from reward dispensing system 108 through reward dispensing aperture 112. Reward feeder mechanism 118 may be a conveyor that conveys reward from reward dispensing system 108 through reward dispensing aperture 112. Motor 122 may interface with reward storage area 116 to dispense a reward from reward dispensing system 108 through reward dispensing aperture 112. Reward feeder mechanism 118 may be a roller feeder used to convey flat rewards such as paper bills or stickers on a roll. One or more sensors (not shown) such as optical sensors, weight sensors, rotation sensors, and the like may be used with reward feeder mechanism 118 of reward dispensing system 108 to ensure a correct reward and reward amount are dispensed.

Reward feeder mechanism 118 may interface with reward chute 126. Reward chute 126 may use gravity to convey reward from reward feeder mechanism 118 through reward dispensing aperture 112. Use of reward chute 126 may allow for variable geometry of reward dispensing aperture 112 relative to reward dispensing system 108, such that a location of reward dispensing aperture 112 may be customized on any of one or more sides 104.

Reward dispensing system 108 may dispense a reward when a triggering event is sensed. Pressure plate sensor 114 may be used to sense a triggering event. Pressure plate sensor 114 may further interface with electrical control 132 to vary and customize the triggering event. For example, in one embodiment, a dog may be rewarded for depositing his toys in receptacle 102. In this example, a dog may have 4 toys each weighing 500 grams. Pressure plate sensor 114 in connection with electrical control 132 may be programmed to trigger a reward event every time an addition of 500 grams to receptacle 102 is sensed by pressure plate sensor 114. Electrical control 132, in connection with pressure plate sensor 114, may trigger an event only when 2 kilograms, for example, of weight is sensed by pressure plate sensor 114 in receptacle 102. Pressure plate sensor 114 in connection with electrical control 132 may be programmed to sense a range of weights. Pressure plate sensor 114 may sense any weight, such that the addition of any item to receptacle 102 may cause a reward triggering event. Electrical control 132 may be further programmed to differentiate triggering events such that different triggering events are rewarded differently. For example, a dog may deposit one 500 gram toy into receptacle 102 and be rewarded with a small amount of a reward, such as kibble, but may deposit 2 kilograms worth of toys into receptacle 102 and be rewarded with a larger amount of reward. Pressure plate sensor 114 in connection with electrical control 132 may sense a removal of items from receptacle 102. Electrical control 132 may be programmed to track additions and removals from receptacle 102. Electrical control 132 may track items removed from receptacle 102 by weight and trigger a reward event only when a substantially similar weight of items if returned to receptacle 102. A reward trigger event may be triggered by removal of items from receptacle 102 as sensed by pressure plate sensor 114. Pressure plate sensor 114 may be a load cell of a beam/strain gauge type.

Sensor 130 may be used in place of or in addition to pressure plate sensor 114. Sensor 130 may be an optical sensor. For example, in crate training a dog, where receptacle 102 is a dog crate or kennel, optical sensor 130 may be used to detect the dog's presence inside the crate to cause a reward triggering event. Sensor 130 may interface with electrical control 132 to provide further customization, such that optical sensor 130 detecting a dog's presence in a crate (e.g., receptacle 102) may only cause a reward triggering event if a dog remains in crate 102 for a given period of time. Optical sensor 130 may track additions and/or removals of items from receptacle 102. Sensor 130 may be a radio-frequency identification (RFID) reader. For example, a dog's toys may be embedded with RFID tags, such that when a dog deposits or removes his toys in receptacle 102, RFID sensor 130 may sense that toys are deposited in receptacle 102 and trigger a reward event. In another example, where a dog is crate trained with receptacle 102 as a crate or kennel, a dog, its collar, or the like, may be implanted with an RFID tag such that RFID sensor 130 senses a dogs presence in crate or kennel 102 and triggers a reward event. Sensor 130 may be a gas or liquid sensor. For example, positive reinforcement training device 100 may be used to toilet train/litter train/house train a cognitive organism, with receptacle 102 used as a toilet or litter box. Gas or liquid sensor 130 may be used to sense a gas emitted by waste product or detect the presence of liquids and trigger a reward event. Sensor 130 may be selected based on training needs and adapted to receptacle 102.

Further embodiments of positive reinforcement training device are possible by programming electrical control 132. For example, for clicker/beeper dog training, a clicker/beeper sound may occur through a speaker (not shown) during a reward triggering event to further associate a trigger event with positive reinforcement. In another example, electrical control 132 may be programmed to run positive reinforcement training device 100 at a particular time of day. For example, electrical control 132 may initiate positive reinforcement training device 100 mid-afternoon such that a dog will clean up his toy before his owner returns from work. In this example, electrical control 132 may be further programmed to issue commands such as “time to clean up” with the dog's name through a speaker (not shown). Electrical control 132 may include an interface such as a display to show device status and usage. Electrical control 132 may include a wired or wireless transmission device (not shown) such that one may remotely control positive reinforcement training device 100 from cell phone or Internet. Reward dispensing system 108 may be wirelessly decoupled from receptacle 102 such that a triggering event in receptacle 102 will cause a reward to be dispensed elsewhere from reward dispensing system 108.

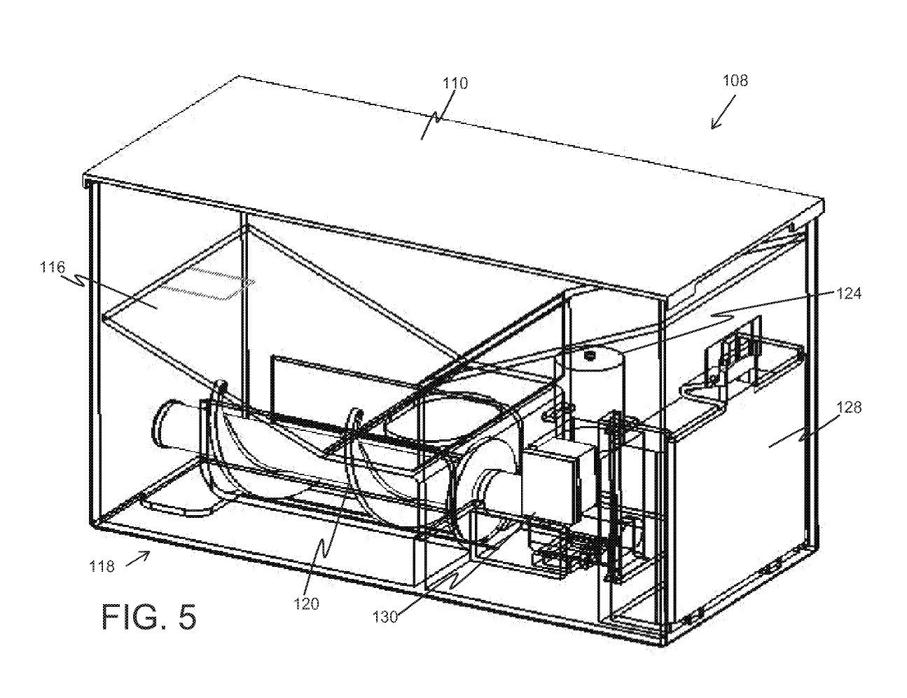

With reference to FIG. 5, another embodiment of reward dispensing system 108 is shown. Reward dispensing system 108 may include access panel 128 to access inner mechanical and electrical components of reward dispensing system 108. Reward dispensing system cover 110 may be used to access reward storage area 116, while access panel 128 may be used to access inner mechanical and electrical components of reward dispensing system 108. Reward dispensing system cover 110 may be used to access both reward storage area 116 and inner mechanical and electrical components of reward dispensing system 108.

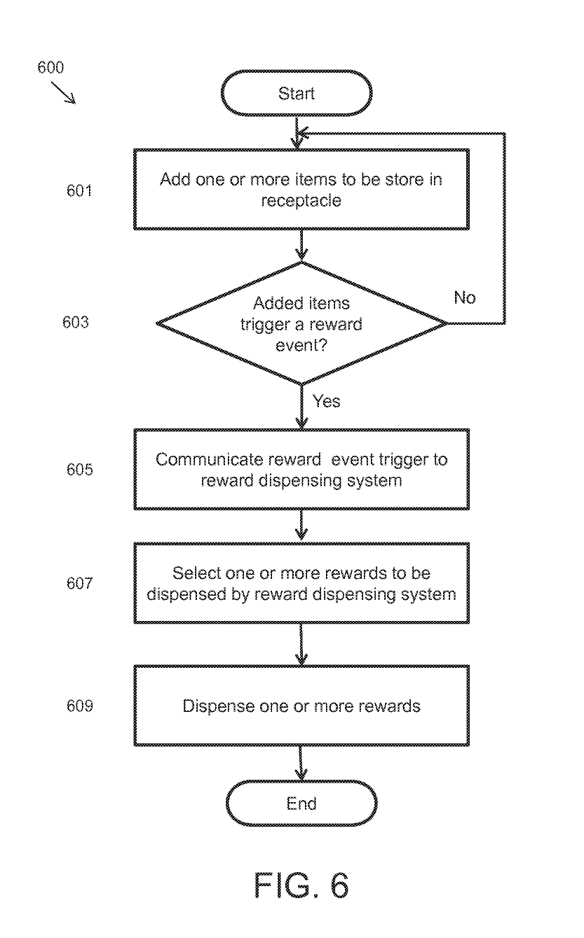

With reference to FIG. 6, a flowchart depicting one embodiment of a method 600 for positive reinforcement training using a positive reinforcement training device is provided. In step 601, one or more removable items to be stored in a receptacle 102 are added to receptacle 102. In step 603, the addition of the one or more removable items to be stored in receptacle 102 is sensed by sensors 114 and/or 130 and a reward event is triggered. In step 605, sensors 114 and/or 130 and electrical control 132 communicate the triggering of reward event to a reward dispensing system 108. In step 607, electrical control 132 selects one or more rewards to be dispensed by the reward dispensing system 108. In step 609, reward dispensing system 108 dispenses the one or more rewards to reward a user for adding one or more items to be stored in receptacle 102.

Unless specifically stated to the contrary, the numerical parameters set forth in the specification, including the attached claims, are approximations that may vary depending on the desired properties sought to be obtained according to the exemplary embodiments. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Furthermore, while the systems, methods, and apparatuses have been illustrated by describing example embodiments, and while the example embodiments have been described and illustrated in considerable detail, it is not the intention of the applicants to restrict, or in any way limit, the scope of the appended claims to such detail. It is, of course, not possible to describe every conceivable combination of components or methodologies for purposes of describing the systems, methods, and apparatuses. With the benefit of this application, additional advantages and modifications will readily appear to those skilled in the art. Therefore, the invention, in its broader aspects, is not limited to the specific details and illustrative example and exemplary embodiments shown and described. Accordingly, departures may be made from such details without departing from the spirit or scope of the general inventive concept. Thus, this application is intended to embrace alterations, modifications, and variations that fall within the scope of the appended claims. The preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising,” as that term is interpreted when employed as a transitional word in a claim. Furthermore, to the extent that the term “or” is employed in the claims (e.g., A or B) it is intended to mean “A or B or both.” When the applicants intend to indicate “only A or B, but not both,” then the term “only A or B but not both” will be employed. Similarly, when the applicants intend to indicate “one and only one” of A, B, or C, the applicants will employ the phrase “one and only one.” Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. Finally, where the term “about” is used in conjunction with a number, it is intended to include ±10% of the number. In other words, “about 10” may mean from 9 to 11.

What is claimed is:

1. A positive reinforcement training device comprising:
a receptacle with an inner volume;
a power supply;
a sensor; and
a reward dispensing system operatively connected to the power supply and the sensor, such that the sensor sensing the addition of items to the inner volume selectively triggers the reward dispensing system to selectively dispense a reward.

2. The device of claim 1, wherein the sensor is a pressure plate sensor including at least one of a load cell and a strain gauge.

3. The device of claim 1, wherein the sensor is an optical sensor.

4. The device of claim 1, wherein the sensor is a radio-frequency identification reader.

5. The device of claim 1, wherein the reward is a sound.

6. The device of claim 1, wherein the reward dispensing system includes a reward feeder mechanism.

7. The device of claim 6, wherein the reward feeder mechanism includes an auger.

8. The device of claim 6, wherein the reward feeder mechanism includes an electro-mechanical actuator.

9. The device of claim 6, wherein the reward feeder mechanism includes an electro-mechanical trap door.

10. The device of claim 6, wherein the reward feeder mechanism includes a conveyor.

11. A positive reinforcement training device comprising:
a receptacle comprising a base surface and one or more side surfaces, the one or more side surfaces connected substantially perpendicular to the base surface, wherein a volume enclosed by the one or more side surfaces and the base surface defines an inner volume;
a power supply;
a sensor operatively connected to the power supply and operatively arranged to sense at least one of an addition and a removal of the one or more items to be stored in the inner volume;
a reward dispensing system operatively connected to the power supply and the sensor, such that the sensor sensing the addition of items to the inner volume selectively triggers the reward dispensing system to selectively dispense a reward, the reward dispensing system further comprising at least one of:
a reward storage area, the reward storage area operable to hold, store, prevent access to the reward until a reward triggering event,
a reward feeder mechanism, the reward feeder mechanism operable to selectively convey one or more rewards from the reward storage area to an award dispensing aperture, the reward feeder mechanism operatively connected to the reward storage area, and
a reward dispensing aperture, the reward dispensing aperture operable to dispense one or more rewards from the reward feeder mechanism after the reward triggering event.

12. The device of claim 11, wherein the sensor is a pressure plate sensor.

13. The device of claim 12, wherein the pressure plate sensor includes at least one of a load cell and a strain gauge.

14. The device of claim 11, wherein the sensor is an optical sensor.

15. The device of claim 11, wherein the sensor is a radio-frequency identification reader.

16. The device of claim 11, wherein the reward feeder mechanism includes an auger.

17. The device of claim 11, wherein the reward feeder mechanism includes an electro-mechanical actuator.

18. The device of claim 11, wherein the reward feeder mechanism includes an electro-mechanical trap door.

19. A method for positive reinforcement training using a positive reinforcement training device, the method comprising:
adding one or more removable items to be stored in a receptacle;
sensing the addition of the one or more removable items to be stored in the receptacle and triggering a reward event;
communicating the triggering of the reward event to a reward dispensing mechanism;
selecting one or more rewards to be dispensed by the reward dispensing system; and
dispensing the one or more rewards to reward a user for adding the one or more items to be stored in a receptacle.

20. The method of claim 19, wherein the positive reinforcement training device comprises:
the receptacle having an inner volume;
a power supply;
a sensor for sensing the addition of the one or more removable items to be stored in the inner volume of the receptacle and triggering a reward event; and
the reward dispensing system operatively connected to the power supply and the sensor, such that the sensor sensing the addition of items to the inner volume selectively triggers the reward dispensing system to selectively dispense the reward.
